(19) United States
(12) Patent Application Publication
(10) Pub. No.: US 2009/0239002 A1
(43) Pub. Date: Sep. 24, 2009

(54) LIQUID CRYSTAL DISPLAY DEVICE, METHOD FOR MANUFACTURING THE SAME, AND ELECTRONIC APPARATUS

(75) Inventor: Nobukazu NAGAE, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/368,477

(22) Filed: Feb. 10, 2009

(30) Foreign Application Priority Data
Mar. 18, 2008 (JP) 2008-069224

(51) Int. Cl. C09K 19/54; B05D 5/06

(52) U.S. Cl. 428/1.2; 427/64

(57) ABSTRACT

A liquid crystal display device includes a pair of substrates, and a liquid crystal layer that is vertically aligned in an initial state and sandwiched between the pair of the substrates. In the device, an alignment layer existing on an uppermost surface of at least one of the substrates is composed of alkyl chains having a different chain length each other, and an alkyl chain having a shortest chain length in the alkyl chains is tilted to the uppermost surface of the at least one of the substrates.

### CROSS-REFERENCE TO RELATED APPLICATION

This application is based on and claims priority from Japanese Patent Application No. 2008-069224, filed on Mar. 18, 2008, the contents of which are incorporated herein by reference.

### BACKGROUND

1. Technical Field

The present invention relates to a liquid crystal display device, a method for manufacturing the liquid crystal display device, and an electronic apparatus.

2. Related Art

In recent years, a vertical alignment mode has been increasingly employed in a liquid crystal display device for a projector as a liquid crystal alignment mode. For forming a vertically aligned layer, a method has been generally known in which inorganic molecules such as SiO₂ and SiO₃ are deposited on electrode surfaces by means of high vacuum deposition processes such as an oblique evaporation method. This method is featured in that no rubbing process is required and a pretilt is easily developed that functions to tilt liquid crystal molecules in one direction. Mass producing the liquid crystal display devices, however, needs expensive equipments such as high vacuum deposition system, causing large initial investment costs and also low productive efficiency as compared with conventional coating processes.

JP-A-2007-286468 is a first example of related art. This example discloses that a roughly vertical or roughly horizontal alignment process can be carried out by providing a silane coupling agent containing an alkyl group on a surface of an inorganic alignment layer formed by an oblique evaporation method. JP-A-2007-127757 is a second example of related art. JP-A-2007-52050 is a third example of related art. These examples disclose methods in which an inorganic alignment layer is surface treated with alcohol and a plurality of silane coupling agents having a different molecule weight each other so as to improve light durability and humidity resistance. These methods are based on the steps of forming an inorganic alignment layer such as SiO₂ and surface treating the alignment layer, making it hard to say they have advantages in productive efficiency as well as costs.

JP-A-8-29759 is a fourth example of related art. The fourth example discloses a method in which a self-assembled film of a silane coupling agent is directly formed on electrodes surfaces as an alignment layer for liquid crystal and polymer dispersed liquid crystal (PDLC). Since the self-assembled layer is formed by directly applying the silane coupling agent on the electrode surfaces of substrates, there is no need to form an inorganic alignment layer by an oblique evaporation method. As a result, the production efficiency can be improved and costs can be reduced. In addition, employing the self-assembled layer as the alignment layer enables low power consumption to be achieved.

The method disclosed in the fourth example, however, does not fully one-axis align liquid crystal molecules when applying a voltage. That is, the liquid crystal molecules are not tilted in one direction since they are uniformly vertically aligned, causing disclination lines.

### SUMMARY

An advantage of the invention is to provide a liquid crystal display device having a good contrast characteristic while preventing display failures such as disclination lines and enabling costs to be reduced, a method for manufacturing the liquid crystal display device, and an electronic apparatus using the device.

According to a first aspect of the invention, a liquid crystal display device includes a pair of substrates, and a liquid crystal layer that is vertically aligned in an initial state and sandwiched between the pair of the substrates. In the device, an alignment layer existing on an uppermost surface of at least one of the substrates is composed of alkyl chains having a different chain length each other, and an alkyl chain having a shortest chain length in the alkyl chains is tilted to the uppermost surface of the at least one of the substrates.

The device has a pair of substrates. The alignment layer on at least one of the substrates has alkyl chains having a different alkyl chain length each other, i.e., alkyl chains having the number of carbon atoms different each other. The alkyl chain having the number of carbon atoms (chain length) smallest in the alkyl chains is tilted to the substrate surface. As a result, the pretilt is given to the alignment layer. This alignment layer makes it possible that the liquid crystal molecules are vertically aligned with the alkyl chain having the long chain length when applying no voltage, while the liquid crystal molecules are aligned in a one-axis direction with the alkyl chain that is tilted to the substrate surface and has the shortest chain length when applying a voltage.

According to a second aspect of the invention, a method for manufacturing a liquid crystal display device that includes a pair of substrates and a liquid crystal layer that is vertically aligned at an initial state and sandwiched between the pair of the substrates, includes: (a) reacting at least two kinds or more of silane coupling agents having a different alkyl chain length each other with a surface of at least one of the pair of the substrates, the surface facing the liquid crystal layer; and (b) tilting an alkyl chain having a shortest chain length of the different alkyl chain lengths to the surface of the at least one of the substrates.

The device has a pair of substrates. The alignment layer provided on at least one of the substrates has alkyl chains having a different alkyl chain length each other. The alkyl chain having the shortest chain length in the alkyl chains is tilted to the substrate surface. As a result, the pretilt is given to the alignment layer. This alignment layer makes it possible that the liquid crystal molecules are practically vertically aligned with the alkyl chain having the longest chain length when applying no voltage while the liquid crystal molecules are aligned in a one-axis direction with the alkyl chain that is tilted to the substrate surface and has the shortest chain length when applying a voltage.

In the step (a), the silane coupling agents come into contact with a surface on which a film may be formed of the at least one of the substrates in an order from a silane coupling agent containing an alkyl group having a longest chain length of the silane coupling agents.

The method enables the alignment layer to be preferably obtained that mainly includes the alkyl group having the longest chain length and is vertically aligned when applying no voltage while aligned in a none-axis direction when applying a voltage. Most part of the surface (electrode) on which a layer is formed of the substrate can be modified with a long-chain alkyl chain group (alkyl group having the longest chain length) after being processed with the silane coupling agent containing the long-chain alkyl group. A clearance is provided between the alkyl groups having the longest chain length neighboring each other due to their steric hindrance. The alkyl group having a shorter chain length (a short-chain alkyl chain group) is formed in the clearance, forming a short-chain alkyl chain region of a minimal area, i.e., a pretilt region.

As a result, the alignment layer can be achieved that enables liquid crystal molecules to be vertically aligned when applying no voltage while tilted in one direction when applying a voltage.

The step (a) may include using a first silane coupling agent containing a long-chain alkyl group having the number carbon atoms of 10 to 20, and using a second silane coupling agent containing a short-chain alkyl group having the number of carbon atoms of 2 to 8.

The method can easily tilt only the short-chain alkyl chain by the rubbing process. In this regard, if the number of carbon atoms of the short-chain alkyl chain is less than half of that of the long-chain alkyl chain having the number of carbon atoms of 10 to 20, only the short-chain alkyl chain can be tilted while the long-chain alkyl chain is kept in the vertical alignment. As a result, the alignment layer can be achieved that enables liquid crystal molecules to be vertically aligned when applying no voltage while tilted in one direction when applying a voltage.

In the step (b), a rubbing process may be carried out.

In the rubbing process, only the short-chain alkyl chain having the smallest molecule weight can be tilted to the substrate surface, whereby a region having the pretilt can be formed. In the process, the long-chain alkyl chain having the largest molecule weight keeps the vertical alignment ability without being influenced by the rubbing process. As a result, the liquid crystal molecules can be vertically aligned when applying no voltage while tilted in one direction when applying a voltage.

According to a third aspect of the invention, an electronic apparatus includes the liquid crystal display device described as above.

The invention can provide a liquid crystal display device having a high quality display with low costs.

The electronic apparatus includes the liquid crystal display device described above. As a result, an electronic apparatus having a high quality display can be provided with low costs.

### BRIEF DESCRIPTION OF THE DRAWINGS

The invention will be described with reference to the accompanying drawings, wherein like numbers reference like elements.

FIG. 1 is a sectional view schematically showing an element structure of a liquid crystal display device according to an embodiment of the invention.

FIG. 2 is a partially enlarged view schematically showing a part (P indicated with a broken line) of FIG. 1.

FIG. 3 is a partially enlarged view schematically showing a part (P indicated with a broken line) of FIG. 1.

FIGS. 4A to 4D are step views showing a manufacturing process of an alignment layer.

FIGS. 5A to 5C are perspective view schematically showing examples of an electronic apparatus of the invention.

### DESCRIPTION OF EXEMPLARY EMBODIMENTS

Embodiments of the invention will now be described below with reference to the accompanying drawings. In the accompanying drawings, the layer thickness and the scale of each element is adequately changed so as to provide each member in a recognizable size.

Liquid Crystal Display Device

A liquid crystal display device of an embodiment of the invention is a transmissive liquid crystal display device of an active matrix type using a thin-film transistor (TFT) as a switching element.

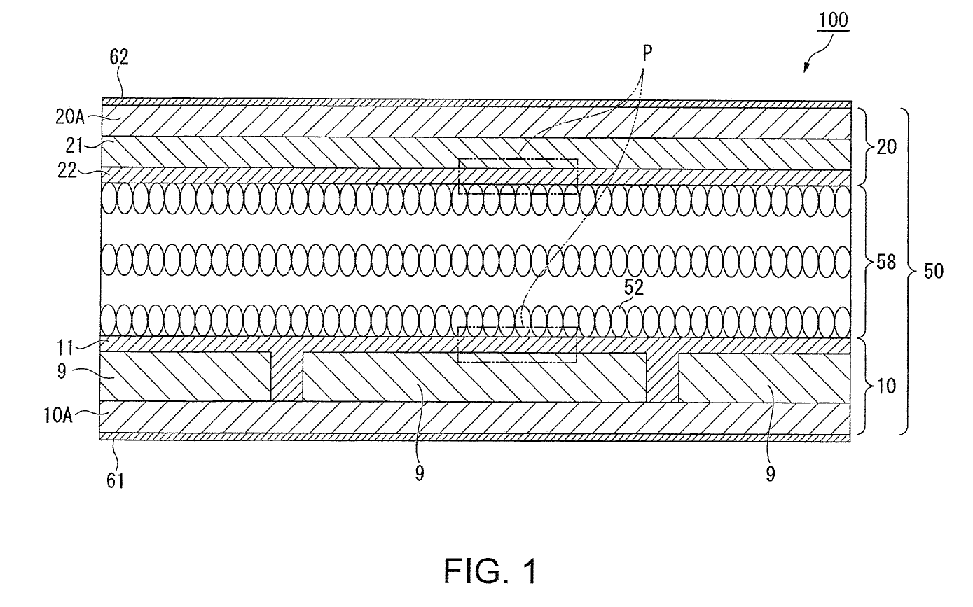

FIG. 1 schematically shows a sectional structure of a liquid crystal display device.

The sectional structure (pixel structure) of the liquid crystal display device of the embodiment is described with reference to FIG. 1.

A liquid crystal panel 50 includes a circuit substrate 10, a counter substrate 20 oppositely disposed to the circuit substrate 10, and a liquid crystal layer 58 sandwiched between the circuit substrate 10 and the counter substrate 20. The liquid crystal layer 58 is made of a liquid crystal material that shows a vertical alignment in an initial alignment state and has negative dielectric anisotropy. The circuit substrate 10 includes a substrate body 10A made of a transparent material such as glass and a pixel electrode 9 formed on an inner surface of the substrate body 10A. The pixel electrode 9 is made of a transparent conductive material such as indium tin oxide (hereinafter, abbreviated as “ITO”) and has a rectangular shape. The circuit substrate 10 also includes TFT elements serving as switching elements to control energizing the pixel electrodes 9, date lines through which image signals are supplied, scan lines, and the like, though all of these are not shown, and may include a function of a light-shielding layer.

The counter substrate 20 includes a substrate body 20A made of a transparent material such as glass and a common electrode 21 that is formed on an inner surface of the substrate body 20A and is made of a transparent conductive film such as ITO. The common electrode 21 is flatly and entirely formed on the substrate body 20A and not divided corresponding to each pixel region. The counter substrate 20 also may include color filters and light-shielding layers.

The counter substrate 20 also includes a first alignment layer 22 so as to cover the common electrode 21 while the circuit substrate 10 includes a second alignment layer 11 so as to cover the pixel electrodes 9. In the liquid crystal layer 58 sandwiched between the counter substrate 20 and the circuit substrate 10, liquid crystal molecules 52 are vertically aligned in an initial state (in which applying a voltage).

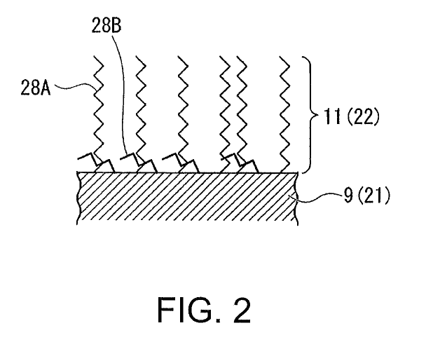

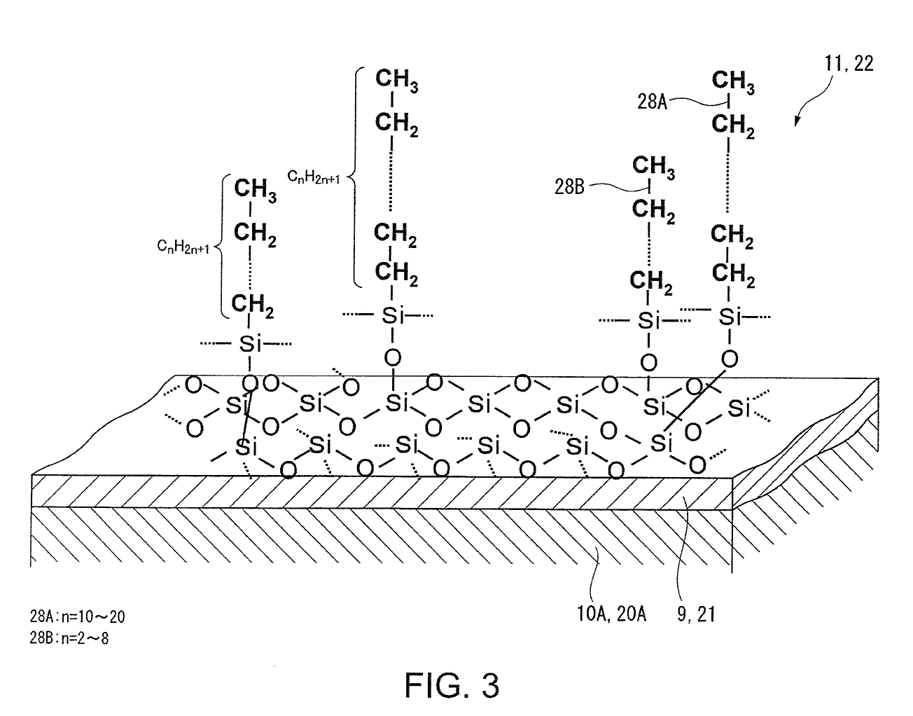

Here, the second alignment layer 11 of the circuit substrate 10 and the first alignment layer 22 of the counter substrate 20 are both distinctive elements of the invention. The specific structures of the first alignment layer 22 and the second alignment layer 11 are described with reference to FIGS. 2 and 3 in which the structures of the first alignment layer 22 and the second alignment layer 11 are schematically shown.

FIGS. 2 and 3 are partial enlarged views showing an enlarged part (P indicated with a broken line) in FIG. 1.

As shown in FIG. 2, the first alignment layer 22 and the second alignment layer 11 are composed of at least two or more kinds of alkyl chains having a different alkyl chain length each other and being on a surface of a substrate. In this case, they are an alkyl chain 28A and an alkyl chain 28B. The surface of the pixel electrode 9 or the common electrode 21 is chemically modified with the alkyl chains 28A and 28B. The alignment layers have a function capable of controlling a tilt angle of liquid crystal molecules in one direction when applying a voltage while the layers are wholly vertically aligned when applying no voltage.

Here, “alkyl chains having a different chain length each other” means that plurality kinds of alkyl chains having the different number of carbon atoms each other. In the embodiment, the alkyl chain 28A has the direct chain that is composed of the larger number of carbon atoms and serves as a long chain while the alkyl chain 28B has the direct chain that is composed of the less number of carbon atoms and serves as a short chain. The first alignment layer 22 and the second alignment layer 11 are composed of the alkyl chains 28A and 28B having the different number of carbon atoms each other. Hereinafter, the alkyl chain 28A is also referred to as the long-chain alkyl chain 28A while the alkyl chain 28B is also referred to as the short-chain alkyl chain 28B.

The first alignment layer 22 is formed by reacting a first silane coupling agent containing a long-chain alkyl group having the number of carbon atoms of 10 to 20 with, for example, an oxide layer of an electrode layer on the substrate surface. Then, a second silane coupling agent containing a short-chain alkyl group having the number of carbon atoms of 2 to 8 is reacted so as to form the second alignment layer 11.

Here, the silane coupling agent includes an organic functional group and a hydrolysis group in a single molecule, by which inorganic substances and organic substances are combined, enabling the physical strength, durability, and adhesiveness of a material to improve. Specifically, it is represented by the following chemical formula 1. An organic functional group and 2 to 3 organic groups reacting with an inorganic substance are bonded to a silicon atom (Si).

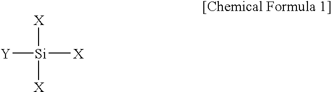

X: hydrolysis group, such as

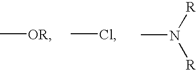

R is an alkyl group. Y: organic functional group reacting with an organic matrix or the like, such as —R.

The silane coupling agent to be used is not particularly limited as long as the organic functional group has good humidity resistance and light durability. Specifically, one having an alkyl group as an organic functional group (Y) in the chemical formula is preferably used. The hydrolysis group is also not particularly limited. For example, a methoxy group (—O—CH₃), or an ethoxy group (—O—C₂H₅) are preferably used.

As shown in FIG. 3, there are two regions on the surfaces of the common electrode 21 and the pixel electrode 9. One is a region modified with the long-chain alkyl chain 28A having the number of carbon atoms of 10 to 20 while the other is a region modified with the short-chain alkyl chain 28B having the number of carbon atoms of 2 to 8. The region modified with the long-chain alkyl chain 28A occupies the majority of the surface while a very few remaining regions is modified with the short-chain alkyl chain 28B but is not modified with the long-chain alkyl chain 28A because of an excluded volume effect. In the first alignment layer 22 and the second alignment layer 11, a long-chain alkyl chain region (the region modified with the long-chain alkyl chain 28A) occupies about 70%. The region modified with the short-chain alkyl chain 28B is also referred to as a short-chain alkyl chain region.

As shown in FIGS. 2 and 3, the long-chain alkyl chain 28A is bonded on the electrodes 9 and 21 in such a manner that the long chain is almost perpendicular to the substrate surface. Thus, the long-chain alkyl chain region has vertical alignment ability. In contrast, the short-chain alkyl chain 28B is subjected to a rubbing process, which will be described later, so that the alkyl chain is tilted with respect to the substrate surface. As a result, the short-chain alkyl chain region has a pretilt (an alignment regulating force on the liquid crystal molecules 52). Here, the short-chain alkyl chain 28B in FIG. 2 is practically tilted to the substrate surface in one direction.

The alignment layers 11 and 22 are subjected to a rubbing process on the surfaces of thin film layers formed by the silane coupling agents. In the rubbing process, only the short-chain alkyl chain 28B is tilted to the substrate surface. As a result, the short-chain alkyl chain region serves as an area giving a predetermined pretilt angle and alignment direction on the liquid crystal molecules 52. In the rubbing process, the long-chain alkyl chain region still keeps its vertical alignment ability without being influenced by the rubbing process. That is, in the alignment layers 11 and 22, the long-chain alkyl chain region vertically aligns the liquid crystal molecules 52 when applying no voltage while the short-chain alkyl chain region functions to guide the liquid crystal molecules 52 in the long-chain alkyl chain region (vertical alignment region) surrounding the short-chain alkyl chain region to a direction in which the liquid crystal molecules 52 are tilted when applying a voltage.

As described above, the first alignment layer 22 and the second alignment layer 11 each has the long-chain alkyl chain region as a major body and wholly shows a vertical alignment while the short-chain alkyl chain region, which occupies a minimal region, has a pretilt (horizontal alignment property).

In the first alignment layer 11 and the second alignment layer 22, the chain lengths of the long-chain alkyl chain 28A and the short-chain alkyl chain 28B are adequately set so as to achieve the above-described alignment functions (vertical alignment ability and pretilt).

As shown in FIG. 1, the liquid crystal layer 58 is sandwiched between the circuit substrate 10 including the first alignment layer 11 structured described as above and the counter substrate 20 including the second alignment layer 22 structured described as above. The liquid crystal layer 58 shows a vertical alignment formed by the first alignment layer 22 and the second alignment layer 11 at an initial alignment state. In this case, the pretilt directions of the short-chain alkyl chain regions in the first alignment layer 22 and the second alignment layer 22, which face each other, coincide in a plane direction

In addition, a pair of polarizing plates 61 and 62 disposed on both sides of the liquid crystal panel 50 in such a manner that the polarization axis of the polarizing plate 61 makes an angle of about 45 degrees with respect to the liquid crystal alignment direction while the polarization axis of the polarizing plate 62 makes an angle of about 135 degrees with respect to the liquid crystal alignment direction. Further, a light source unit (not shown) is disposed below the polarizing plate 61. The liquid crystal display device 100 of the embodiment is thus structured.

In the liquid crystal display device 100, when applying no voltage, the liquid crystal molecules 52 in the liquid crystal layer 58 sandwiched between the circuit substrate 10 and the counter substrate 20 are wholly vertically aligned. In the liquid crystal layer 58, however, part of the liquid crystal molecules 52 is roughly horizontally aligned or has a pretilt by the action of the short-chain alkyl chain region in the first alignment layer 22 and the second alignment layer 11. As a result, the liquid crystal molecules are uniformly tilted according to the pretilt directions of the first alignment layer 22 and the second alignment layers 11 suppressing an alignment regulating force due to a lateral electric field generated out of an end portion of the pixel electrode 9 when applying a voltage.

In the embodiment, the first alignment layer 22 and the second alignment layer 11 are composed of the alkyl chains 28A and 28B having a different molecular weight. Specifically, the short-chain alkyl chain 28B tilted is mixed to the long-chain alkyl chain 28A that occupies the major portion and extends vertically on the substrate surface. As a result, each alignment layer has a vertical alignment ability in a partial region. That is, each of the alignment layers 11 and 22 shows wholly vertical alignment property while having a horizontal alignment property in the minimal region.

Consequently, the liquid crystal molecules are tilted in one direction when applying a voltage suppressing the influences of a lateral electric field generated out of the pixel electrode 9 whereas vertical alignment property is shown when applying no voltage, enabling high transmission to be achieved.

Manufacturing Method

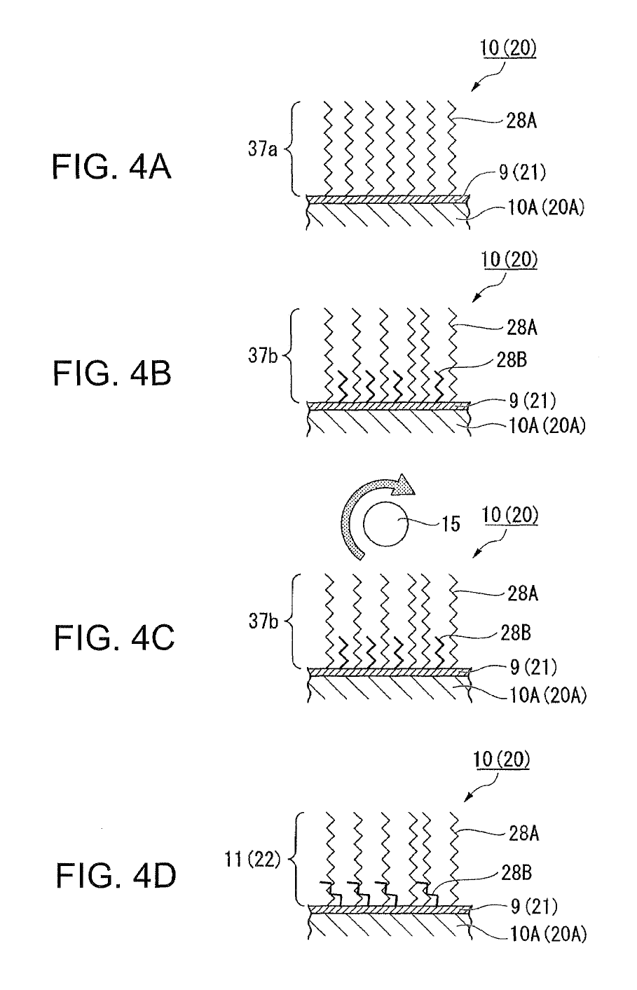

A method for manufacturing a liquid crystal display device according to another embodiment of the invention is described. FIGS. 4A to 4D are step views showing a manufacturing process of an alignment layer.

First, the substrate body 20A is prepared that is made of glass or the like and has a transparency. Then, a second light-shielding layer 23, the common electrode 21, and the like are formed by a known method. The substrate body 10A is also prepared that is made of glass or the like and has a transparency. Then, a first light-shielding layer 11a, a semiconductor layer la, various kinds of wiring lines 3a, 3b, and 6b, the pixel electrodes 9, and the like are formed by a known method.

Subsequently, the first silane coupling agent containing a long-chain alkyl group having the number of carbon atoms of 10 to 20 is made contact with the common electrode 21 on the substrate body 20A and the pixel electrodes 9 on the substrate body 10A (a first layer forming process step). The method for contacting the first silane coupling agent with them is not particularly limited. Various methods can be employed in addition to the method described above. A gas phase reaction method, a dipping method (dip coating method), a spray coating method, various printing methods, and an inkjet method are preferably used.

Since the alignment layers 22 and 11 are formed on roughly overall surfaces facing the liquid crystal layer 58 of the substrate bodies 10A and 20A respectively in the embodiment, the following exemplary method is preferably employed because of its easiness. The outer surfaces (surfaces at sides opposite to the surfaces facing the liquid crystal layer 58) of the substrate bodies 10A and 20A are masked, and then the substrate bodies 10A and 20A are dipped into the first silane coupling agent. The outer surfaces serve as the front and back surfaces of the liquid crystal panel 50.

In the dipping method, the substrate bodies 10A and 20A that have the electrodes 9 and 21 respectively are dipped into the first silane coupling agent for a predetermined time. As a result, as shown in FIG. 4A, the surfaces of the pixel electrodes 9 and the common electrode 21 are modified with the long-chain alkyl group. That is, a thin film layer 37a composed of the long-chain alkyl chain 28A is formed on the roughly overall surface of each of the substrate bodies 10A and 20A. The long-chain alkyl chains 28A neighboring each other are bonded on the pixel electrodes 9 and the common electrode 21 with a gap between them because of the influence of steric hindrance. Thus, practically, approximately 70% of the total surface of each of the substrate bodies 10A and 20A is roughly uniformly modified with the long-chain alkyl chain 28A.

Subsequently, the substrate bodies 10A and 20A each having the monomolecular layer 37a are dipped into the second silane coupling agent containing the short-chain alkyl group having the number of carbon atoms of 2 to 8 for a predetermined time (a second layer forming process step). As a result, as shown in FIG. 4B, the short-chain alkyl group is bonded to the electrode surface in a network structure of the long-chain alkyl chain 28A bonded on each of the pixel electrodes 9 and the common electrode 21, whereby a thin film layer 37b composed of the long-chain alkyl chain 28A and the short-chain alkyl chain 28B is formed.

Then, as shown in FIG. 4C, the thin film layer 37b composed of the long-chain alkyl chain 28A and the short-chain alkyl chain 28B is subjected to a rubbing process with a rubbing processing device 15 having a roller with a rubbing cloth rub thereon. As a result, as shown in FIG. 4D, only the short-chain alkyl chain 28B is tilted to the substrate surface. Almost all of the short-chain alkyl chains 28B are tilted along the rubbing direction by the rubbing process since they easily move to the substrate surface due to the short chain length. While some of the short-chain alkyl chains 28B may be tilted without the rubbing process depending on the number of carbon atoms of the short-chain alkyl chain 28B or a ratio of the number of carbon atoms between the long-chain alkyl chain 28A and the short-chain alkyl chain 28B, it is preferable that the rubbing process be carried out in order to wholly align the tilted direction of the short-chain alkyl chains 28B.

In this regard, the chain length of the long-chain alkyl chain 28A is kept roughly perpendicular to the substrate surface with being little affected by the rubbing process as well as without being fallen down.

As a result of the rubbing process on the thin film layer 37b, the short-chain alkyl chain region (nominal region) has a pretilt and an alignment direction. That is, the short-chain alkyl chain region having the pretilt is formed in the long-chain alkyl chain region having the vertical alignment ability. Through the steps described above, the first alignment layer 22 and the second alignment layer 11 are respectively formed on the substrate body 10A and the substrate body 20A.

The processing condition of the rubbing process is adequately set depending on a kind of the silane coupling agent or the like because the rubbing processing ratio of the short-chain alkyl chain 28B varies with reaction temperature, reaction time, or the like.

Table 1 shows a relation between a combination of silane coupling agents having different alkyl chain length each other and alignment function of liquid crystal.

A: a vertical alignment was confirmed when applying no voltage while a one-axis horizontal alignment was confirmed when applying a voltage.

B: a vertical alignment was not confirmed when applying no voltage while a one-axis horizontal alignment was not confirmed when applying a voltage.

NA: Untested.

TABLE 1

The number of carbon
atoms of long-chain alkyl

| | | 10 | 12 | 16 | 18 |
|---|---|---|---|---|---|
| The number | 2 | A | A | NA | A |
| of carbon | 4 | A | A | A | NA |
| atoms of | 6 | B | A | A | NA |
| short-chain | 8 | NA | NA | B | A |
| alkyl | | | | | |

As shown in Table 1, an alignment layer was formed by using the first silane coupling agent containing a long-chain alkyl group having the number of carbon atoms of 10 and the second silane coupling agent containing a short-chain alkyl group having the number of carbon atoms of 4, a vertical alignment was confirmed when applying no voltage while a one-axis horizontal alignment was confirmed when applying a voltage. The desired alignment function as described above was also confirmed in a case where another aliment layer was formed with a combination of a silane coupling agent containing a long-chain alkyl group having the number of carbon atoms of 12 and another silane coupling agent containing a short-chain alkyl group having the number of carbon atoms of 6.

Based on the results shown in Table 1, it was found that the following combination enables liquid crystal molecules to be vertically aligned when applying no voltage and to turn into a one-axis horizontal alignment when applying a voltage. The combination is that a silane coupling agent containing a long-chain alkyl group having at least the number of carbon atoms of about 10 to about 12 and another silane coupling agent containing a short-chain alkyl group having the number of carbon atoms of half or below of that of the long-chain alkyl group.

However, the alignment function described as above was not confirmed regardless whether a voltage was applied or was not applied in a case where an alignment layer was formed with the combination of a silane coupling agent containing a long-chain alkyl group having the number of carbon atoms of 10 and another silane coupling agent containing a short-chain alkyl group having the number of carbon atoms of 6. Likewise, the desired alignment function was also not confirmed in the combination of a silane coupling agent containing a long-chain alkyl group having the number of carbon atoms of 16 and another silane coupling agent containing a short-chain alkyl group having the number of carbon atoms of 8.

Based on the results, it was found that when the chain length of the long-chain alkyl group is long because of increasing the number of carbon atoms thereof, the desired alignment function was not able to be obtained even though the short-chain alkyl group having the number of carbon atoms of half of that of the long-chain alkyl group was used as a combination.

In this regard, depending on the number of carbon atoms of the long-chain alkyl group, the desired alignment function can be obtained even though the number of carbon atoms of the short-chain alkyl group is half of that of the long-chain alkyl group. Because of this, the combination is adequately set depending on the layer forming conditions or the like.

The circuit substrate 10 and the counter substrate 20, which were manufactured as described above, were bonded in such a manner that the rubbing directions of the first alignment layer 22 and the second alignment layer 11, both of which face each other, were in an anti-parallel direction. Then, a negative type liquid crystal material was injected through an injection hole. The injection hole was sealed to complete the liquid crystal panel 50. Then, the polarizing plates 61 and 62 were settled in such a manner that their transmission axes respectively make angles of about 45 degrees and about 135 degrees with respect to the alignment direction of the liquid crystal panel 50, i.e., the rubbing direction, whereby the liquid crystal display device 100 was completed.

In the liquid crystal display device 100 structured as described above, when applying no voltage, the liquid crystal molecules 52 included in the liquid crystal layer 58 is vertically aligned between the substrates 10 and 20 by the action of the long-chain alkyl chain region of each of the alignment layers 11 and 22. In contrast, when applying a voltage, the liquid crystal molecules 52 is horizontally aligned so as to be along the rubbing direction by the action (the pretilt) of the short-chain alkyl chain region of each of the alignment layers 11 and 22.

In the liquid crystal display device 100 of a vertical alignment type of the embodiment, a layer forming process was carried out in which two kinds of silane coupling agents containing alkyl groups having a different chain length (the number of carbon atoms) were respectively reacted with oxide layers on the substrate bodies 10A and 20A in order to obtain the first alignment layer 22 and the second alignment layer 11 each composed of the long-chain alkyl chain 28A and the short-chain alkyl chain 28B. In the embodiment, the surface of each of the electrodes 9 and 21 was modified with the long-chain alkyl chain 28A and the short-chain alkyl chain 28B, and then alignment property was given to the short-chain alkyl chain region, which is a nominal region, by the rubbing process. Since the short-chain alkyl chain 28B is provided in the clearance between the alkyl chains 28A by utilizing the steric hindrance of the long-chain alkyl chain 28A, alignment layers can be formed in which the long-chain alkyl chain regions serve as the major body and the short-chain alkyl chain regions to which pretilts are given by the rubbing process are roughly uniformly distributed on the electrodes 9 and 21 without being unevenly distributed. Because of the structure, when applying a voltage, the short-chain alkyl chain region preferably functions as a guide to indicate the alignment direction of the liquid crystal molecules 52 in the long-chain alkyl chain region (vertically alignment region) surrounding the short-chain alkyl chain region.

According to the manufacturing method of the embodiment, since the alignment layers 11 and 22 are formed by a coating process (specifically, a dipping method), vacuum deposition systems used in related art high vacuum processes are not required. As a result, the alignment layers 11 and 22 can be formed with high productive efficiency by using a coating process in the atmospheric pressure without a huge investment.

In addition, since a vacuum deposition method such as a sputtering method is not employed, dust, which usually occurs in the vacuum deposition process, is eliminated, reducing the defective rate. Consequently, a vertically aligned light valve having a superior display quality can be provided with low costs.

As for the layer forming process with the silane coupling agent, a chemical vapor deposition method also can be employed as well as the coating method described above. In the chemical vapor deposition method, the substrate bodies 10A and 20A respectively having the electrodes 9 and 21 may be put into a chamber capable of being tightly closed, and then the silane coupling agent may be introduced into the chamber as steam for surface treatment.

Specifically, as an example, the substrate bodies 10A and 20A respectively having the electrodes 9 and 21 are dried for about 3 hours at about 150 to about 180 degrees centigrade in a N₂ atmosphere, and then the substrate bodies 10A and 20A are left inside a tightly closed chamber together with a container holds, for example, an octadecyltrimethoxysilane (ODS) solution (the first silane coupling agent) therein. The container is heated, for example, at 150 degrees centigrade for about 1 hour, whereby vapor of the ODS solution comes into contact with the surfaces of the electrodes 9 and 21 of the respective substrate bodies 10A and 20A. As a result, the long-chain alkyl group of the ODS molecule is bonded on the electrodes 9 and 21 since the long-alkyl group has an inorganic reactive group.

Subsequently, after the long-chain alkyl group is bonded on the electrodes 9 and 21, the substrate bodies 10A and 20A are transferred to another tightly closed chamber in which a container holds the second silane coupling agent therein is disposed. Alternatively, the container holds the first silane coupling agent may be replaced with the container holds the second silane coupling agent in the same tightly closed chamber. As a result, the short-chain alkyl chain 28B may be bonded to the clearance among the long-chain alkyl chains 28A on the electrodes 9 and 21, whereby the first alignment layer 22 and the second alignment layer 11 may be formed.

As described above, the aliment films 11 and 22 formed by using the chemical vapor deposition process also can demonstrate the same effect as that of the above-described embodiment.

### EXAMPLE 1

A 1% by weight solution of octadecyltriethoxysilane in methanol solution was prepared. The circuit substrate 10 and the counter substrate 20 were immersed in the solution for 30 minutes, and then taken out. The substrates were cleaned with dekalin, and then heated at 120 degrees centigrade for 1 hour in a heated oven (a long-chain alkyl chain process). Then, the circuit substrate 10 and the counter substrate 20 were immersed in a 1% by weight solution of butyltrimethoxysilane in methanol for 30 minutes. Subsequently, the cleaning and drying were conducted in the same manner as described above. This was a short-chain alkyl chain process.

The surfaces of the circuit substrate 10 and the counter substrates 20 were subjected to the rubbing process with a typical rubbing process device in such a manner that the set rubbing directions are aligned with a one-axis direction when the substrates are combined. The surfaces face the liquid crystal layer and were surface treated with the silane coupling agents having a different molecule weight each other.

Then, the circuit substrate 10 and the counter substrate 20 were combined. Negative type liquid crystal (Δε is negative) was injected through an injection hole, and then the injection hole was sealed to complete a liquid crystal panel. The polarizing plates were settled on both sides of the liquid crystal panel made as described above so that their transmission axes respectively make angles of about 45 degrees and about 135 degrees with respect to the rubbing direction under the crossed nicols condition. As a result, a liquid crystal display element was made. Electrical signals were applied to the liquid crystal display element so as to display black and white images. The images having a very high display quality were obtained respectively in white images and black images. In the white images, a bright white display was displayed that came from the liquid crystal aligned uniformly in a one-direction in every pixel. In the black images, a sharp black display was displayed without light leakage due to the vertical alignment of the liquid crystal.

Electronic Apparatus

Examples of the electronic apparatus equipped with the liquid crystal display device of the above-described embodiments are described.

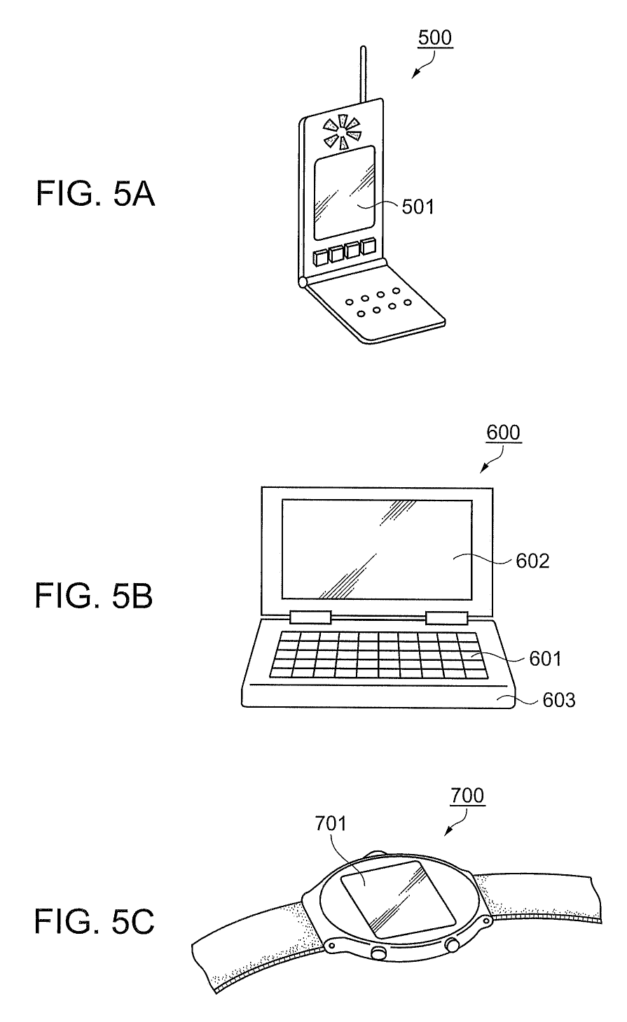

FIG. 5A is a perspective view showing an example of cellular phones. In FIG. 5A, a mobile phone body 500 has a liquid crystal display 501 using the liquid crystal display device of the embodiments.

FIG. 5B is a perspective view showing an example of portable information processing devices such as word processors and personal computers. In FIG. 5B, an information processing unit 600 includes: an input section 601 such as a keyboard; an information processing unit body 603; and a liquid crystal display 602 using the liquid crystal display device of the embodiments.

FIG. 5C is a perspective view showing an example of wristwatch-type electronic equipment. In FIG. 5C, a watch body 700 includes a liquid crystal display 701 using the liquid crystal display device of the embodiments.

The electronic apparatuses shown in FIGS. 5A to 5C employ the liquid crystal display device, which is an example of the invention, as the displays. Therefore, the electronic apparatuses can maintain a high contrast and high quality display for a long period of time without problems of displaying rubbing stripes caused by a rubbing process, for example.

The preferred embodiments of the invention have been described with reference to the accompanying drawings as above. The invention is not limited to the embodiments and examples, and they may be combined. Naturally, those skilled in the art will able to presume many variations and modifications within the purview of the technical idea disclosed in the scope of claims of the invention. It will be understood that those variations and modifications are obviously within the technical scope of the invention.

In the embodiments, the alignment layer is formed with two kinds of alkyl chains having a different molecule weight each other, but the invention is not limited to this. For example, the alignment layer may be formed with a plurality kinds of alkyl chains if the following condition is satisfied. The ratio of the alkyl chain tilted to the substrate surface to the alkyl chain kept in the vertical alignment in the rubbing process is about 1:7. The liquid crystal molecules can be vertically aligned when applying no voltage while can be aligned in a one-axis direction when applying a voltage.

In the embodiments, the aliment films 22 and 11 of the respective substrates 10 and 20 are composed of alkyl groups having a different molecule weight each other. However, only one alignment layer may be employed. In this case, investment costs can be reduced as compared with a conventional case in which the alignment layers of the substrates sandwiching the liquid crystal layer are formed by a vacuum process since the number of expensive vacuum film forming apparatuses can be reduced.

In addition, the alignment layer may be formed by the following exemplified manner. An underlayer that is made of an inorganic material and disposed under the alignment layer is formed by the coating process so as to cover the electrodes on the substrate. Then, a surface treatment is carried out with a plurality of kinds of silane coupling agents containing alkyl groups having a different molecule weight each other so as to from the alignment layer.

What is claimed is:

1. A liquid crystal display device, comprising:
a pair of substrates; and
a liquid crystal layer that is vertically aligned in an initial state and sandwiched between the pair of the substrates, wherein: an alignment layer existing on an uppermost surface of at least one of the substrates is composed of alkyl chains having a different chain length each other; and an alkyl chain having a shortest chain length in the alkyl chains is tilted to the uppermost surface of the at least one of the substrates.

2. A method for manufacturing a liquid crystal display device that includes a pair of substrates and a liquid crystal layer that is vertically aligned in an initial state and sandwiched between the pair of the substrates, the method comprising:
(a) reacting at least two kinds or more of silane coupling agents having a different alkyl chain length each other with a surface of at least one of the pair of the substrates, the surface facing the liquid crystal layer; and
(b) tilting an alkyl chain having a shortest chain length of the different alkyl chain lengths to the surface of the at least one of the substrates.

3. The method for manufacturing a liquid crystal display device according to claim 2, wherein, in step (a), the silane coupling agents come into contact with a surface on which a film is formed of the at least one of the substrates in an order from a silane coupling agent containing an alkyl group having a longest chain length of the silane coupling agents.

4. The method for manufacturing a liquid crystal display device according to claim 2, wherein step (a) includes: using a first silane coupling agent containing a long-chain alkyl group having a number carbon atoms of 10 to 20; and using a second silane coupling agent containing a short-chain alkyl group having a number of carbon atoms of 2 to 8.

5. The method for manufacturing a liquid crystal display device according to claim 2, wherein, in step (b), a rubbing process is carried out.

6. An electronic apparatus, comprising the liquid crystal display device according to claim 1.
